(19) United States
(12) Patent Application Publication
(10) Pub. No.: US 2007/0016421 A1
(43) Pub. Date: Jan. 18, 2007

(54) Correcting a pronunciation of a synthetically generated speech object

(75) Inventors: Jani Nurminen, Lempaala (FI); Hannu Mikkola, Tampere (FI); Jilei Tian, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/180,316

(22) Filed: Jul. 12, 2005

(51) Int. Cl. G10L 13/08

(52) U.S. Cl. 704/260

(57) ABSTRACT

This invention relates to a method, a device and a software application product for correcting a pronunciation of a speech object. The speech object is synthetically generated from a text object in dependence on a segmented representation of the text object. It is determined if an initial pronunciation of the speech object, which initial pronunciation is associated with an initial segmented representation of the text object, is incorrect. Furthermore, in case it is determined that the initial pronunciation of the speech object is incorrect, a new segmented representation of the text object is determined, which new segmented representation of the text object is associated with a new pronunciation of the speech object.

### FIELD OF THE INVENTION

This invention relates to a method, a device and a software application product for correcting a pronunciation of a speech object, wherein said speech object is synthetically generated from a text object in dependence on a segmented representation of said text object, and wherein a pronunciation of said speech object is associated with said segmented representation of said text object.

### BACKGROUND OF THE INVENTION

Synthetic generation of Speech Objects (SOs) is typically encountered in Text-To-Speech (TTS) systems that allow to automatically convert Text Objects (TOs), such as for instance numbers, symbols, letters, words, phrases or sentences, into speech objects, such as audio signals. SOs then can be rendered in order to make the TO heard by a user. Applications of such TTS systems are manifold. For instance, TTS systems may allow to make textual information intelligible to visually impaired persons. TTS systems are also advantageous in so-called eyes-busy situations, for instance in automotive scenarios where a user is driving a car and concurrently uses an application that actually requires visual interaction with a display, such as browsing a menu structure of the car's audio system or searching a name from an address book of a telecommunications device. TTS systems allow to dispense with visual interaction with a display by transforming the TOs displayed on the display into SOs that then can be read to the user. The user, in turn, then may use voice control to make selections or to trigger operations.

The basic set-up of a prior art TTS unit 1 is depicted in FIG. 1. The TTS unit 1 comprises a TTS front-end with an automatic phonetization unit 12 and a speech synthesis unit 11, and is capable of converting a TO into an SO. To this end, the automatic phonetization unit 12 of front-end 10 first determines a phonetic representation (PR) of the TO by means of text-to-phoneme mapping (also frequently denoted as grapheme-to-phoneme mapping). The PR of the TO is basically a sequence of phonemes, which are the smallest possible linguistic units. For instance, the TO “segmentation” may be converted into the PR “s-eh-g-m-ax-n-t-ey-sh-ix-n”. Text-to-phoneme mapping, also denoted as grapheme-to-phoneme mapping, may for instance be performed by dictionary-based, rule-based or data-driven modeling approaches or combinations thereof.

The PR of the TO from the automatic phonetization unit 12, possibly together with further information on the TO determined by the TTS front-end 10, such as stress information, break information, segmentation information and/or context information, is then input into speech synthesis unit 11, which synthesizes the TO to obtain an SO. Speech synthesis may for instance be accomplished by Linear Predictive Coding (LPC) synthesis or formant synthesis, to name but a few. In LPC synthesis, for instance, speech is modeled by a source-filter approach, wherein an excitation signal is considered to excite a vocal tract that is modeled by a set of LPC coefficients.

For each phoneme, then segment-specific excitation parameters and LPC coefficients may be stored in speech synthesis unit 11 and recalled in response to the PR of the TO received.

A serious problem with prior art TTS systems is that it is sometimes impossible to automatically derive the correct pronunciation for a TO. The pronunciation of an SO obtained from TTS conversion of a TO is generally coupled to the PR of the TO, which PR is determined by the automatic phonetization unit 12 of the TTS front-end 10. Consequently, an incorrect PR of a TO results in a mispronunciation of the generated SO.

A typical example situation in which practically every user will face the problem of mispronunciation of synthetically generated SOs is the deployment of a TTS system to convert names of an address book into speech, as it is for instance the case in a voice dialing application. Many persons have names with such special pronunciations that they cannot be handled correctly by the prior art TTS systems. Moreover, many of these names are so rare that it is not possible for TTS system developers to include all of them as exceptional pronunciations. In these cases, if the pronunciation of the automatically generated SO is very far from the correct one, the usability of the voice dialing application may become rather poor since it can sometimes even be difficult for the user to verify whether the call triggered by the voice dialer is going to the right person. Even though the user might eventually adapt to recognize the poor pronunciations, the erroneous TTS output will probably irritate the user every time he/she makes a call to a person with a difficult name.

In prior art TTS systems, the frequency of occurrence of mispronunciations of SOs may be reduced by the TTS system developers by improving the automatic phonetization unit 12 (see FIG. 1); this however increases the complexity of the phonetization unit 12 and limits applicability of the TTS unit 1 in low-cost and low-complexity applications.

Furthermore, there also exists a number of indirect approaches to cope with mispronunciations of SOs:
The input TO may be slightly modified, and it then may be tried to synthesize the modified TO again. Sometimes an incorrect spelling can lead to correct pronunciation of the generated SO. However, in systems utilizing both visual and auditory feedback, the incorrect spellings may cause confusion due to the inconsistency between the feedbacks.
The wording of the input TO may be changed by replacing the difficult TO with its synonym. Often, the synonym will be easier to pronounce (However, sometimes there may be no applicable synonyms for the TO to be synthesized, in particular when names have to be synthesized.).

As a back-up solution, it may also be imagined that a TTS system offers the possibility to record a spoken representation of the difficult TO, i.e. to obtain a recorded SO, separately, and to use the recorded SO instead of the SO synthetically generated by the TTS system. A corresponding exemplary TTS system 2 is depicted in FIG. 2.

Therein, the TO is first input into an input control instance 20, where it is checked if there already exists a recorded SO for this TO. If this is not the case, the TO is forwarded to the TTS unit 24, which converts the TO into an SO, as already described with reference to the TTS unit 1 of FIG. 1. The synthetically generated SO then is forwarded to pronunciation control unit 23, which renders or causes the rendering of the SO, so that it can be heard by a user, and subsequently checks if a user is satisfied with the pronunciation of the SO. If the user is satisfied with the pronunciation, the SO may be forwarded by pronunciation control unit 20 to further processing stages, and no further action is required by the TTS system, because it is now known that the TO can be automatically converted into an SO by the TTS system with satisfactory pronunciation. Nevertheless, pronunciation control unit 23 may signal the successful generation of the SO to input control unit 20, which signaling is depicted as dashed arrow in FIG. 2. If the user is not satisfied with the pronunciation of the SO, pronunciation control unit 23 has to signal this information back to input control unit 20 to trigger the recording of a spoken representation of the TO.

In response to a signaling that the pronunciation of the generated SO is not satisfactory, received from pronunciation control unit 23, input control unit 20 memorizes the TO as not being automatically convertible into an SO and signals to the speech recorder 21 that a representation of the TO, spoken by the user, is to be recorded (see the dashed arrow in FIG. 2). To this end, the input control unit 20 may furthermore trigger a visual or audio request to inform the user of the requirement for a recording, accordingly. Speech recorder 21 then records the spoken representation of the TO, i.e. produces the recorded SO, and stores the recorded SO in a speech signal memory 22. The recorded SO may optionally be output by SO memory 22 to further processing stages, for instance to a rendering unit to allow the user to control/correct the recorded SO.

Upon the reception of the next TO, input control unit 20 thus may check if the TO is memorized as not being automatically convertible, and then speech object memory 22 may be triggered to output the recorded SO that corresponds to the received TO. In contrast, if the received TO is not memorized as not being automatically convertible (or is memorized as being automatically convertible), input control unit 20 forwards the TO to TTS unit 24 for conversion, and instructs pronunciation control unit 23 to render the generated speech object without prompting the user. The speech object may also optionally be output by pronunciation control unit 23 to further processing stages.

The apparent downside of the TTS system according to FIG. 2 is that the recorded SO will most likely have very different voice characteristics when compared to the TTS output, i.e. the user can hear that the recorded SO is spoken by a different person. Depending on the application, there may also arise confusing situations with different voices for different recorded SOs. Moreover, the quality of the recorded SO, which may for instance have been recorded with a mobile phone, may be very low compared to the TTS output. It may for instance have low dynamics, be subject to background noise, possibly be clipped, and its signal level may be inconsistent with the signal level of the synthetically generated SOs. Finally, also a large amount of memory is required for storing recorded SOs.

### SUMMARY OF THE INVENTION

In view of the above-mentioned problem, it is, inter alia, an object of the present invention to provide an improved method, device and software application product for correcting a pronunciation of a speech object.

According to the present invention, a method is proposed for correcting a pronunciation of a speech object, wherein said speech object is synthetically generated from a text object in dependence on a segmented representation of said text object. Said method comprises determining if an initial pronunciation of said speech object, which initial pronunciation is associated with an initial segmented representation of said text object, is incorrect; and determining, in case it is determined that said initial pronunciation of said speech object is incorrect, a new segmented representation of said text object, which new segmented representation of said text object is associated with a new pronunciation of said speech object.

Said text object may represent any textual information, as for instance numbers, symbols, letters, words or combinations thereof (such as phrases or sentences). Said speech object may represent an audio signal in any possible audio format, wherein said audio format can be an analog or digital audio format. Said speech object is particularly suited for being rendered, for instance by means of a loudspeaker. Said synthetic generation of said speech object from said text object may for instance be performed in a TTS system. Said segmented representation of said text object comprises one or more segments said text object has been segmented into. Said segments may for instance be phonemes (the smallest linguistic units). If said segments are phonemes, said segmented representation is a phonetic representation of said text object. Said synthetic generation of said speech object may for instance depend on said segmented representation of said text object in a way that the speech object is generated from the segmented representation of the text object, for instance by using a-priori information on the synthesis of speech for each segment in the segmented representation. In said synthetic generation of said speech object, in addition to said segmented representation of said text object, further information may be considered as well, such as for instance stress, break and/or context information or any other symbolic linguistic information.

An initial pronunciation of said speech object may be considered to be correct or incorrect with respect to a generally used pronunciation or a pronunciation that a user prefers for said text object. For instance, said consideration may be affected by a dialect spoken or preferred by a user. Said determination if said initial pronunciation of said speech object is incorrect may for instance be performed actively by prompting a user, or passively by expecting an action performed by a user. In the latter case, the user may for instance have the possibility to inform a system that operates said pronunciation correction method that said initial pronunciation of said speech object is incorrect, for instance by voice interaction or by hitting a function key or the like. If no such user action takes place, the method assumes that said initial pronunciation is correct. Equally well, said determination if said initial pronunciation of said speech object is incorrect may be performed automatically.

If it is determined that said initial pronunciation is incorrect, a new segmented representation of said text object is generated with an associated new pronunciation. Said new pronunciation may for instance be the correct pronunciation of said text object, or an improved pronunciation with respect to said initial pronunciation. Said new segmented representation may then for instance be stored for future generation of said speech object with said new pronunciation.

According to the present invention, when an incorrect initial pronunciation of said synthetically generated speech object is detected, a new segmented representation of said text object is determined. This segmented representation of said text object then may serve as a basis for an anew synthetic generation of said speech object with said new pronunciation. Therein, since said (anew) synthetic generation of said speech object with said new pronunciation does not differ from the synthetic generation of other speech objects with pronunciations that do not require correction, it may not be differentiated from the speech objects if a correction of the pronunciation has actually taken place or not. This efficiently removes the major disadvantages of the TTS system presented with reference to FIG. 2 above, where in case of a mispronunciation, a spoken representation of the text object is recorded and then used as recorded speech object together with speech objects that were obtained from synthetic generation. Furthermore, if said new segmented representation of said text object is stored for future generation of said speech object with said new pronunciation, significantly less memory is required as compared to the TTS system of FIG. 2 where a spoken representation of the text object has to be stored.

According to the method of present invention, said new segmented representation of said text object may be stored to serve as a basis for a synthetic generation of said speech object with said new pronunciation. Storage of said new segmented representation of said text object may contribute to avoiding future mispronunciations. Before determining an initial segmented representation of a text object, it may then be first checked if a stored segmented representation of said text object exists, and then directly said stored segmented representation of said text object may be used as a basis for the synthetic generation of said speech object.

According to the method of the present invention, said determining of said new segmented representation of said text object may comprise generating one or more candidate segmented representations of said text object, wherein each of said one or more candidate segmented representations of said text object is associated with a respective candidate pronunciation of said speech object, and selecting said new segmented representation of said text object from said one or more candidate segmented representations of said text object. Said generating of said one or more candidate segmented representations of said text object may be accomplished in a variety of ways, for instance based on said text object, and/or based on a spoken representation of said text object. Said one or more candidate segmented representations of said text object may for instance be generated at once, or sequentially.

According to the method of the present invention, said selecting may comprise prompting a user to select said new segmented representation of said text object from said one or more candidate segmented representations of said text object. For each candidate segmented representation of said text object, then said speech object with the corresponding candidate pronunciation may be rendered, and the user then may select the candidate segmented representation of said text object with the best associated candidate pronunciation. Before or during said selection, said one or more candidate segmented representations may be checked for suitability to serve as said new segmented representation of said text object, and may be automatically discarded to limit the number of alternatives a user may have to choose from. If, after said checking and eventual discarding of candidate segmented representation of said text object, only one of said one or more candidate segmented representations of said text object are left, the user may be prompted to confirm that said candidate segmented representation of said text object is determined to be said new segmented representation of said text object.

According to a first embodiment of the method of the present invention, said generating of said one or more candidate segmented representations of said text object comprises obtaining a representation of said text object spoken by a user; and converting said spoken representation of said text object into said one or more candidate segmented representations of said text object.

Said user may for instance be prompted to say the text object, and said spoken representation of said text object then may be obtained by recording. Said spoken representation of said text object then is converted into said one or more candidate segmented representations of said text object, wherein in said conversion, speech information, and thus information related to the pronunciation of the text object as it is considered to be correct by the user, can be exploited to find candidate segmented representations with improved associated pronunciations.

According to the first embodiment of the method of the present invention, said converting may be performed by an automatic speech recognition algorithm. If said segmented representation of said text object is a phonetic representation, said automatic speech recognition algorithm may for instance be a phoneme-loop automatic speech recognition algorithm. Therein, said speech recognition algorithm may achieve particularly high estimation accuracy since, unlike to standard speech recognition scenarios, in the present case, both the spoken representation of the text object and its written form may be known. Furthermore, there is no need to go beyond the phoneme level, and consequently, no disambiguation problem (assigning phonemes correctly to words) arises. Said automatic speech recognition algorithm may at least partially use a mapping between text objects and their associated segmented representations, wherein said mapping is at least partially updated with the new segmented representations of text objects which are determined in case that initial pronunciations associated with initial segmented representations of said text objects are incorrect. By said updating, said automatic speech recognition algorithm may be adapted to a user's speech, so that also automatic speech recognition performance increases. Said mapping may for instance be represented by a vocabulary with a segmented representation for each word in the vocabulary. Said mapping may be used both for the determining of the initial segmented representation of the text object, and for the converting of said spoken representation of said text object into said one or more candidate segmented representations of said text object.

According to the first embodiment of the method of the present invention, a written form of said text object may be considered in said converting of said spoken representation of said text object. Said written form of the text object may particularly be exploited in the converting to get an estimate of the range of the number of segments in said segmented representation of said text object. Furthermore, knowledge on the written form of the text object may be exploited to limit the number of possible alternatives of said segmented representation of said text object.

According to the first embodiment of the method of the present invention, a difference between said initial pronunciation of said speech signal and a pronunciation of said spoken representation of said text object may be considered in said converting of said spoken representation of said text object. Said difference may particularly limit the variety of possible segmented representations of said text object to a sub-part of said segmented representation of said text object, for instance to a sub-group of segments of said segmented representation of said text object (e.g. the first segments if said segmented representation of said text object).

According to the first embodiment of the method of the present invention, said selecting may comprise automatically assessing a suitability of at least one of said one or more candidate segmented representations of said text object to serve as said new segmented representation of said text object; and discarding said at least one candidate segmented representation of said text object, if it is assessed to be not suitable to serve as said new segmented representation of said text object.

Said discarding reduces the number of candidate segmented representations of said text object a user may have to select from, and thus increases convenience for the user.

According to the first embodiment of the method of the present invention, said assessing may be based on at least one of rules, a language-dependent statistical n-gram technique and a pronounceable classifier technique. An example of a rule may for instance be a sound-related rule demanding that each text object, e.g. a word, has to comprise a vowel. Statistical n-gram techniques may for instance be statistical uni-gram or bi-gram techniques. In uni-gram techniques, a probability of the occurrence of a single segment (e.g. a single phoneme) is considered, whereas in a bi-gram technique, the conditional probability of a second segment, given a first segment, is considered. For instance, in a bi-gram technique, a candidate segmented representation of a text object may be discarded if it contains two adjacent segments and the probability that the second of these two segments follows on the first of these two segments equals 0 or is at least very low. Pronounceable classifier techniques attempt to assess if segments in a candidate segmented representation of a text object can be pronounced at all.

According to the first embodiment of the method of the present invention, said assessing may be based on comparing a pronunciation of said spoken representation of said text object with the candidate pronunciation associated with said at least one candidate segmented representation of said text object. Said comparing may target to detect matches or differences between said pronunciations.

According to a second and third embodiment of the method of the present invention, said generating of said one or more candidate segmented representations of said text object comprises converting said text object into said one or more candidate segmented representations of said text object. In contrast to the first embodiment, in said second and third embodiment, the text object itself, and not a spoken representation thereof, serves as a basis for the generating of said one or more different candidate segmented representations.

According to the second and third embodiments of the method of the present invention, said converting is performed by an automatic segmentation algorithm. If said segmented representation of said text object is a phonetic representation, said automatic segmentation algorithm may for instance be an automatic phonetization algorithm.

According to the second embodiment of the method of the present invention, said selecting comprises obtaining a representation of said text object spoken by a user; automatically assessing a suitability of at least one of said one or more candidate segmented representations of said text object to serve as said new segmented representation of said text object, wherein said assessing is based on comparing a pronunciation of said spoken representation of said text object with the candidate pronunciation associated with said at least one candidate segmented representation of said text object; and discarding said at least one candidate segmented representation of said text object, if it is assessed to be not suitable to serve as said new segmented representation of said text object. Said spoken representation of said text object then is exploited to reduce the number of said one or more candidate segmented representations of said text object, so that a user, when being prompted to select said new segmented representation of said text object from said one or more candidate segmented representations of said text object, may have to evaluate less alternatives.

According to the present invention, furthermore a device is proposed for correcting a pronunciation of a speech object, wherein said speech object is synthetically generated from a text object in dependence on a segmented representation of said text object. Said device comprises means arranged for determining if an initial pronunciation of said speech object, which initial pronunciation is associated with an initial segmented representation of said text object, is incorrect; and means arranged for determining, in dependence on said determination if said initial pronunciation of said speech object is incorrect, a new segmented representation of said text object, which new segmented representation of said text object is associated with a new pronunciation of said speech object.

The device of the present invention may further comprise means arranged for storing said new segmented representation of said text object, which serves as a basis for a synthetic generation of said speech object with said new pronunciation.

According to the device of the present invention, said means arranged for determining said new segmented representation of said text object may comprise means arranged for generating one or more candidate segmented representations of said text object, wherein each of said one or more candidate segmented representations of said text object is associated with a respective candidate pronunciation of said speech object, and means arranged for selecting said new segmented representation of said text object from said one or more candidate segmented representations of said text object.

According to the device of the present invention, said means arranged for selecting said new segmented representation of said text object from said one or more candidate segmented representations of said text object may comprise means arranged for prompting a user to select said new segmented representation of said text object from said one or more candidate segmented representations of said text object.

According to a first embodiment of the device of the present invention, said means arranged for generating said one or more candidate segmented representations of said text object comprises means arranged for obtaining a representation of said text object spoken by a user; and means arranged for converting said spoken representation of said text object into said one or more candidate segmented representations of said text object.

According to the first embodiment of the device of the present invention, said means arranged for selecting said new segmented representation of said text object from said one or more candidate segmented representations of said text object may comprise means arranged for automatically assessing a suitability of at least one of said one or more candidate segmented representations of said text object to serve as said new segmented representation of said text object; and means arranged for discarding said at least one candidate segmented representation of said text object, in case it is assessed to be not suitable to serve as said new segmented representation of said text object.

According to a second and third embodiment of the device of the present invention, said means arranged for generating said one or more candidate segmented representations of said text object comprises means arranged for converting said text object into said one or more candidate segmented representations of said text object.

According to the second embodiment of the device of the present invention, said means arranged for selecting said new segmented representation of said text object from said one or more candidate segmented representations of said text object comprises means arranged for obtaining a representation of said text object spoken by a user; means arranged for automatically assessing a suitability of at least one of said one or more candidate segmented representations of said text object to serve as said new segmented representation of said text object, wherein said assessing is based on comparing a pronunciation of said spoken representation of said text object with the candidate pronunciation associated with said at least one candidate segmented representation of said text object; and means arranged for discarding said at least one candidate segmented representation of said text object in case it is assessed to be not suitable to serve as said new segmented representation of said text object.

Said device of the present invention may be a portable telecommunications device or a part thereof.

According to the present invention, furthermore a software application product is proposed for correcting a pronunciation of a speech object, wherein said speech object is synthetically generated from a text object in dependence on a segmented representation of said text object, said software application product being embodied within a computer readable medium and being configured to perform the steps of determining if an initial pronunciation of said speech object, which initial pronunciation is associated with an initial segmented representation of said text object, is incorrect; and determining, in case it is determined that said initial pronunciation of said speech object is incorrect, a new segmented representation of said text object, which new segmented representation of said text object is associated with a new pronunciation of said speech object.

These and other aspects of the invention will be apparent from and elucidated with reference to the embodiments described hereinafter.

### BRIEF DESCRIPTION OF THE FIGURES

In the figures show:

FIG. 1: A Text-To-Speech (TTS) unit for converting a Text Object (TO) into a Speech Object (SO) based on a Phonetic Representation (PR) of said TO according to the prior art;

FIG. 2: an exemplary TTS system for correcting mispronunciations;

FIG. 3a: a schematic block diagram of a first embodiment of a TTS system according to the present invention;

FIG. 3b: a flowchart of the general method steps performed by the first, second and third embodiments of a TTS system according to the present invention;

FIG. 3c: a flowchart of the specific method steps performed by the first embodiment of a TTS system according to the present invention;

FIG. 4a: a schematic block diagram of a second embodiment of a TTS system according to the present invention;

FIG. 4b: a flowchart of the specific method steps performed by the second embodiment of a TTS system according to the present invention;

FIG. 5a: a schematic block diagram of a third embodiment of a TTS system according to the present invention; and

FIG. 5b: a flowchart of the specific method steps performed by the third embodiment of a TTS system according to the present invention.

### DETAILED DESCRIPTION OF THE INVENTION

The present invention relates to the correction of a pronunciation of a Speech Object (SO), wherein said SO is synthetically generated from a Text Object (TO) in dependence on a segmented representation of said TO. It is determined if an initial pronunciation of said SO, which initial pronunciation is associated with an initial segmented representation of said TO, is incorrect. In case it is determined that said initial pronunciation of said SO is incorrect, a new segmented representation of said TO is determined, which new segmented representation of said TO is associated with a new pronunciation of said SO.

In the detailed description which follows, the present invention will be explained by means of exemplary embodiments. Therein, said segmented representation of said TO is assumed to be a Phonetic Representation (PR) of said TO. It should however be noted that this choice is of exemplary nature only, and that the present invention also applies to the correction of mispronunciations in the context of other segmented representations of said TO.

A TTS system according to the present invention may for instance be used in an audio menu application to enable usage of the most relevant features of a mobile phone (or a car phone) in eyes-busy situations. The audio menu application may for instance enable calling a contact from a contact list with the aid of audio feedback for menu items and contact list names. The user is then able to browse the audio menu structures and to perform the most important operations without seeing the phone's display. This is done by designing the menu structures to be relatively simple and by giving audio feedback from every action the user makes in the menu (e.g. movements, selections, etc.).

In this kind of application, it is typical to use TTS conversion or recorded audio prompts for the audio output. Since all the texts cannot be known in the software development phase (e.g. contact list names), a TTS system must be used at least for converting the corresponding TOs into SOs.

In the mainstream applications, the speech synthesis can be done using a high quality, large footprint TTS system. In TTS systems for portable devices, such as for instance mobile phones, however, an embedded TTS system has to be used due to the inherent limitations on complexity and memory consumption. The smaller footprint increases the probability of synthetically generated SOs with incorrect pronunciation, which in turn highly decreases the usability of the TTS system.

The present invention offers a user the possibility to correct such mispronunciations, and thus can bring significant improvements to this kind of application. The option to correct mispronunciations may for instance be offered to the user when she/he is storing a new contact in the contact list of the mobile phone. In this way, the user is not disturbed with additional dialogs at the time she/he is trying to make a call.

### First Embodiment of the Invention

In the first embodiment of the present invention, an Automatic Speech Recognition (ASR) unit generates the one or more candidate PRs of the TO based at least on a spoken representation of the TO.

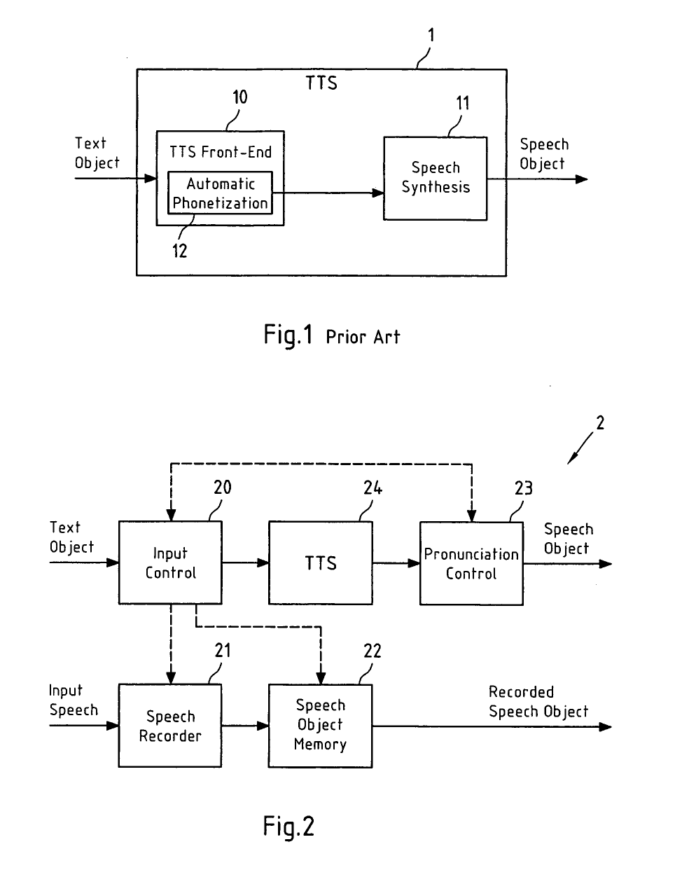

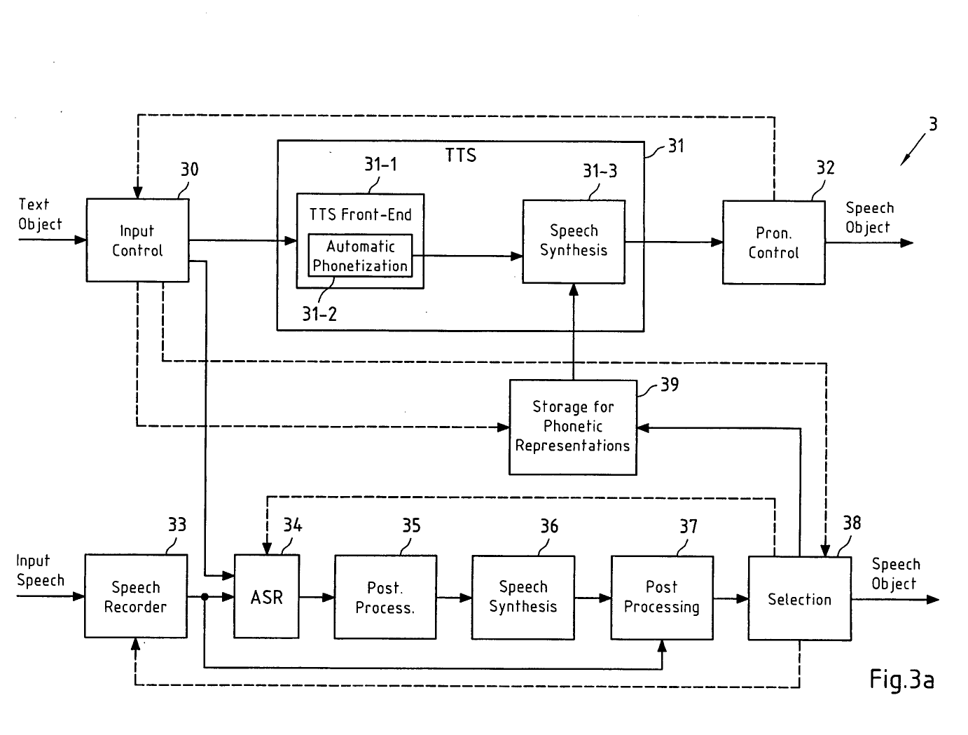

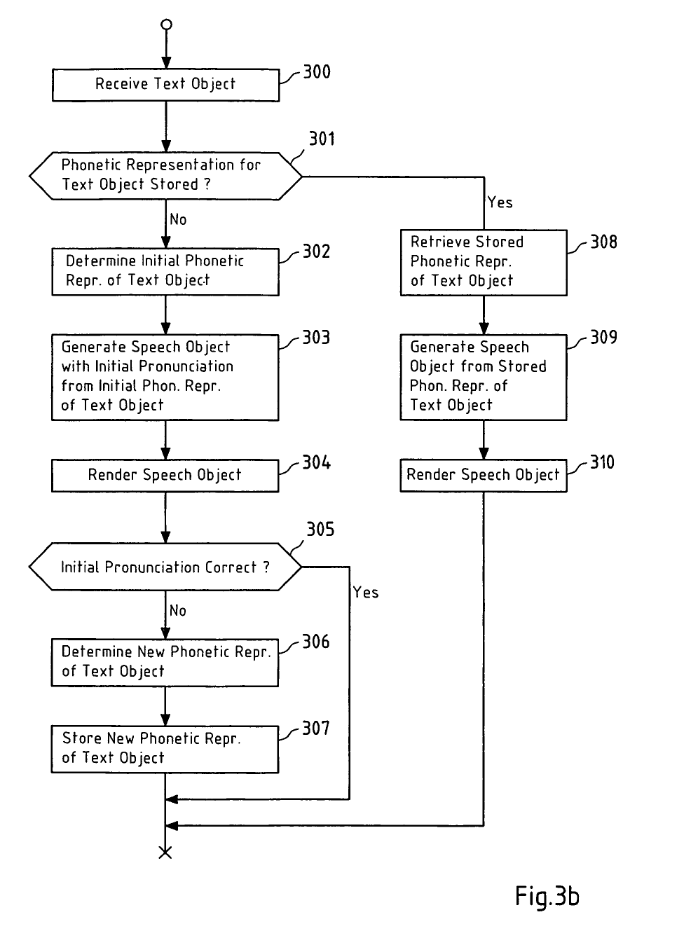

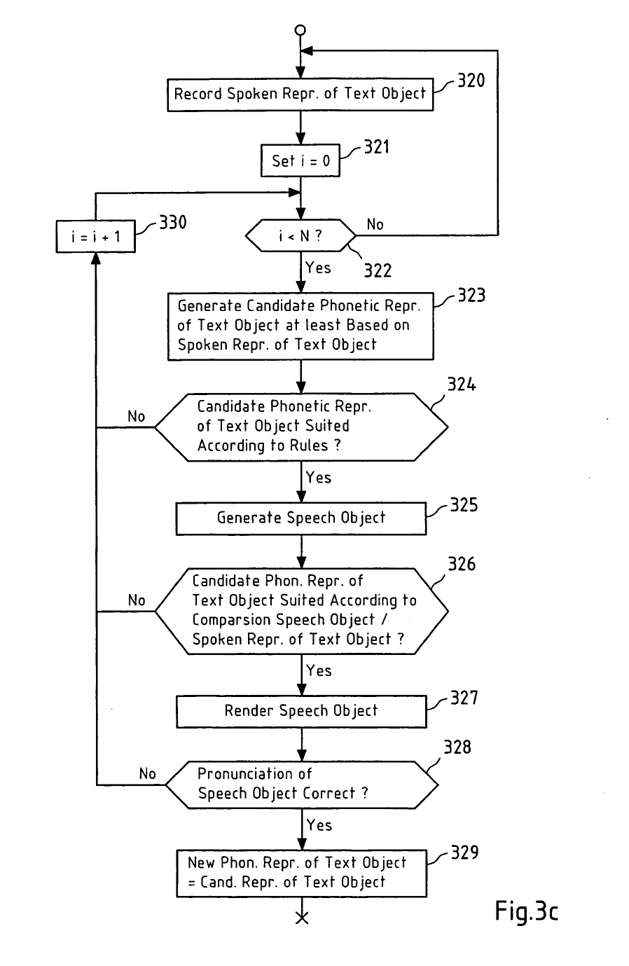

FIG. 3a depicts a schematic block diagram of this first embodiment of a TTS system 3 according to the present invention. The TTS system 3 comprises a TTS unit 31 with TTS front-end 31-1, automatic phonetization unit 31-2 and speech synthesis unit 31-3. The functionality of this TTS unit 31 resembles the functionality of the TTS unit 1 of FIG. 1 and thus does not require further explanation, apart from the fact that the speech synthesis unit 31-3 of TTS system 31 is capable of receiving both PRs of a TO (sequences of one or more phonemes representing the TO) as generated by the automatic phonetization unit 31-2, and PRs of a TO stored in the storage unit 39, and that speech synthesis unit 31-3 is also capable of forwarding both the generated SO and the PR of the TO based on which the SO was generated to the pronunciation control unit 32.

An input control unit 30 of the TTS system 3 is capable of receiving a TO that is to be converted by the TTS system 3, as for instance a contact of a contact list. Equally well, said TO may stem from an entire sentence of a text and has been isolated for pronunciation correction purposes before. The input control unit 30 is further capable of checking if a PR of said TO has already been determined before. For this situation, input control instance 30 is capable of triggering the transfer of this stored representation from a storage unit 39 to speech synthesis unit 31-3 of TTS unit 31. This triggering is accomplished by a control signal, which is visualized in FIG. 3a, as are all control signals in the block diagrams of the present invention, by means of dashed arrows. In contrast, transfer of actual data and transfer of both data and control signals is represented by a drawn-through arrow. Input control unit 30 is also capable of transferring the received TO to the TTS unit 31 (which occurs in case that no PR of the TO is stored in storage unit 39), of receiving a control signal and an initial PR of the TO from a pronunciation control unit 32, wherein the control signal indicates that an initial pronunciation of an SO (associated with the initial PR of the TO) generated by TTS unit 31 is incorrect, and of transferring the received TO and the initial PR of the TO to an Automatic Speech Recognition (ASR) unit 34.

Pronunciation control unit 32 is capable of receiving an SO generated by TTS unit 31, together with the PR of the TO from which the SO was generated, and of determining if a pronunciation of this SO is correct. To this end, said pronunciation control unit 32 may for instance comprise means for rendering or causing the rendering of the SO, and means for accessing a user interface for communicating with a user, so that a user may decide if said pronunciation of said SO is correct or not. For the latter decision case, the pronunciation control unit 32 is capable of sending a control signal indicating that said pronunciation is incorrect to input control unit 30. In addition to said control signal, also the initial PR of the TO that led to the incorrect pronunciation of the SO is transferred to the input control unit 30. Said pronunciation control unit 32 may also be capable of outputting said SO to further processing stages.

Storage unit 39 is capable of receiving said control signal from the input control unit 30, of outputting a stored PR of a specific TO (in response to said control signal), and of receiving PR of TOs to be stored from selection unit 38.

The TTS system 3 further comprises a speech recorder 33 being capable of receiving a representation of a TO spoken by a user, of forwarding this spoken representation to ASR unit 34 and of receiving a control signal from selection unit 38, which triggers said recording and forwarding.

ASR unit 34 is arranged to receive a TO and an initial PR of said TO from input control instance 30, to receive a spoken representation of said TO from speech recorder 33 and a control signal from selection unit 38. In response to this control signal, ASR unit 34 generates one or more candidate PRs of the TO based on said received spoken representation of said TO, and optionally said TO and/or said initial PR of said TO. A possible core functionality of said ASR unit 34 is for instance described in document “Acoustics-only Based Automatic Phonetic Baseform Generation” by B. Ramabhadran, L. R. Bahl, P. V. desouza and M. Padmanabhan, published in proceedings International Conference on Acoustics, Speech and Signal Processing (ICASSP), Seattle, Wash., USA, May 12-15, 1998. More details on the operation of the ASR unit 34, in particular with respect to the optional consideration of the TO and the initial PR of the TO in the process of generating candidate PRs of the TO, will be described below.

The post processing unit 35 is capable of receiving one or more candidate PRs of a TO output by ASR unit 34, and of applying rules, language-dependent statistical n-gram techniques (e.g. uni-gram or bi-gram techniques) and/or pronounceable classifier techniques to the one or more candidate PRs in order to cancel invalid candidate PRs. It is also capable of signaling such a canceling to the selection unit 38 (as illustrated by the dashed arrow). It should be noted that post processing unit 35 is optional for the first embodiment of a TTS system 3 according to the present invention.

Speech synthesis unit 36, similar to speech synthesis unit 31-3, is capable of receiving one or more candidate PRs of a TO and, based on the received candidate PRs of said TO, to synthetically generate a SO, wherein the respective candidate pronunciations of the generated SO depend on said one or more candidate PRs of said TO. The generated SO for each of the one or more candidate PRs of said TO can furthermore be output by speech synthesis unit 36, together with the corresponding candidate PRs of said TO.

A further post processing unit 37 is capable of receiving the generated SO for each of the one or more candidate PRs of said TO and the corresponding candidate PRs of said TO themselves, from speech synthesis unit 36, and to compare the one or more candidate pronunciations of said received SO with a pronunciation of the spoken representation of a TO received from speech recorder 33, in order to assess if at least one of said candidate pronunciations of said SO is invalid, so that the corresponding candidate PR of the TO should be discarded. Post processing unit 37 is further capable of forwarding non-discarded candidate PRs of said TO together with the SO with the corresponding candidate pronunciation to selection unit 38, and of signaling information that the candidate PR of the TO should be discarded to the selection unit 38 (as illustrated by the dashed arrow). It should be noted that post processing unit 37 is optional for the first embodiment of a TTS system 3 according to the present invention.

Selection unit 38 is capable of receiving the output of post processing unit 37, i.e. one or more candidate PRs of a TO and, for each of said candidate PRs of the TO, the SO with the corresponding candidate pronunciation. Selection unit 38 is capable of rendering or causing the rendering of said SO with said one or more candidate pronunciations, and of communicating with a user to allow the user to select the candidate pronunciation (and thus the corresponding candidate PR of the TO) that the user considers to be correct (or close to correct) with respect to said TO. Said selection unit 38 is further capable of transferring the candidate PR of said TO that has been selected by the user to storage 39, and may also be capable of outputting the SO with the candidate pronunciation that corresponds to the selected candidate PR of said TO to further processing stages. Said selection unit 38 is also capable of triggering speech recorder 33 to obtain a spoken representation of a TO, and of controlling the ASR unit 34 (illustrated by the dashed arrows), as will be explained in more detail below.

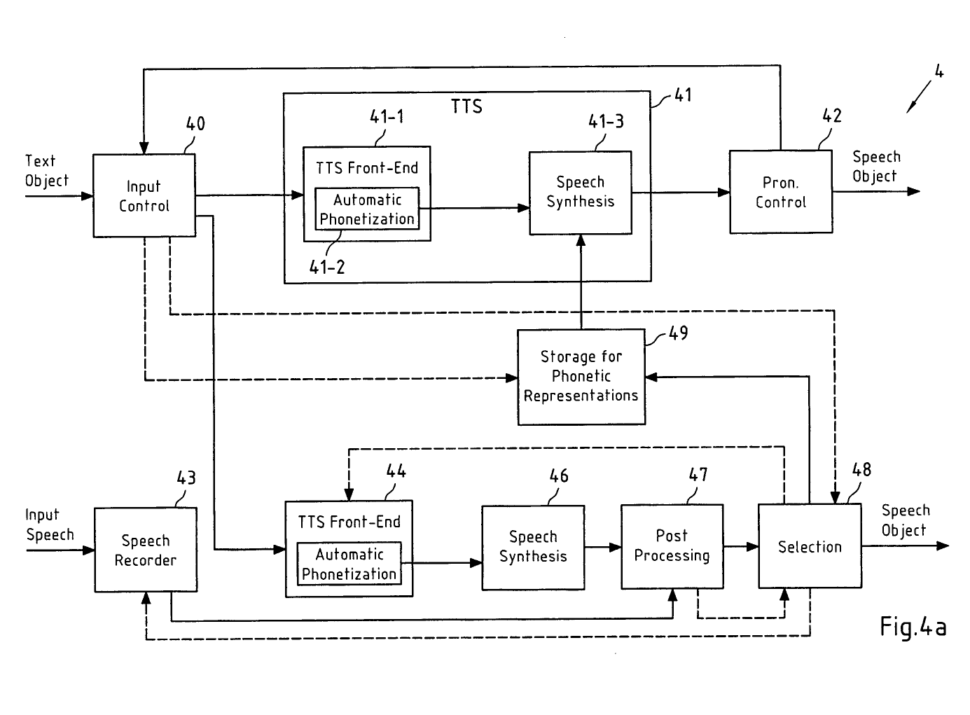

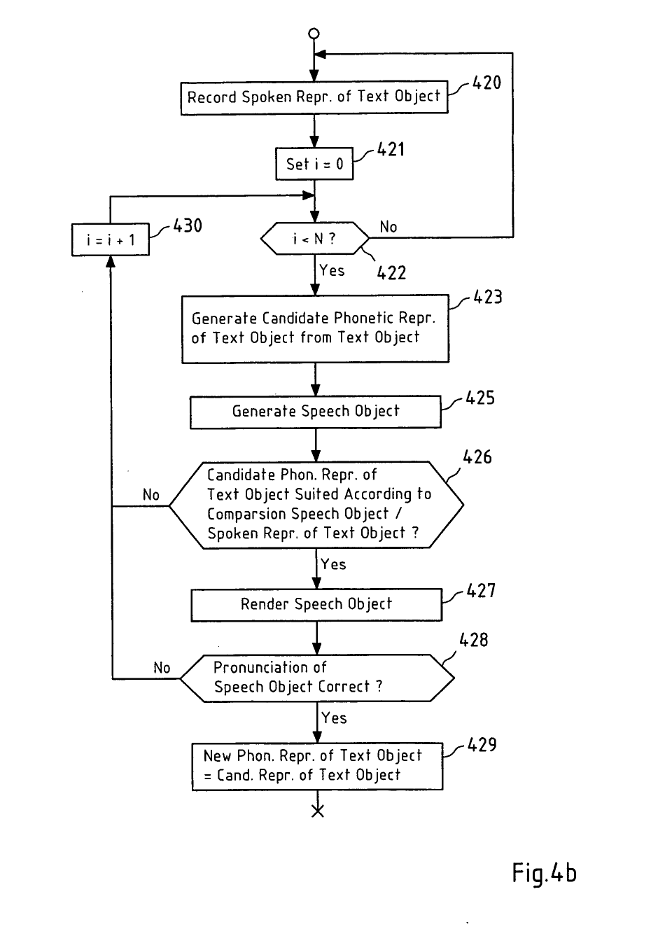

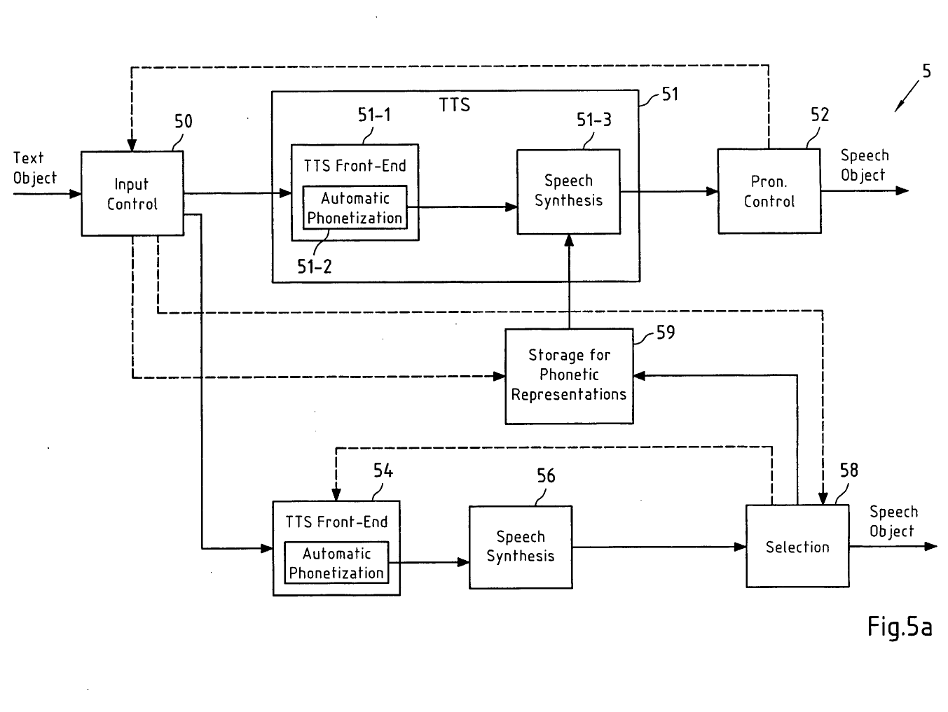

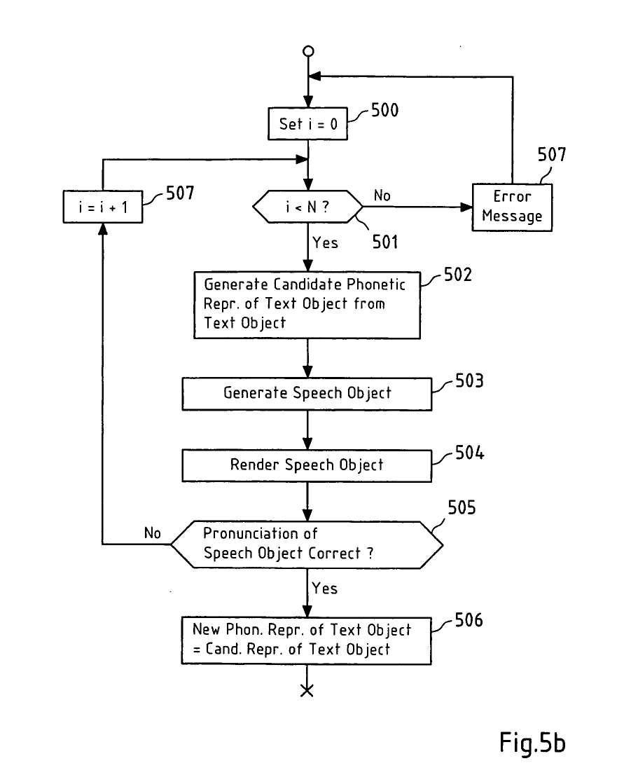

FIG. 3b presents a flowchart of the method steps performed by the first embodiment of a TTS system 3 (see FIG. 3a) according to the present invention. It should be noted that this flowchart is of rather general nature and is thus also applicable to the second and third embodiments of a TTS system according to the present invention, which will be discussed below with reference to FIGS. 4a, 4b and FIGS. 5a, 5b, respectively.

In a first step 300, a TO, which is to be converted into an SO, is received. This may for instance be a contact list name that is currently entered by the user into a contact list of a mobile phone. The reception of the text object takes place at the input control unit 30 (see FIG. 3a). In a second step 301, it is checked if a PR for this TO has been determined and stored before (by performing steps 302-307 of the flowchart of FIG. 3b, as will be explained below). This check is also performed by input control unit 30 (see FIG. 3a). If it is determined that no PR is available for the received TO, an initial PR of the TO is determined in step 302. This step is performed by automatic phonetization unit 31-2 in TTS front-end 31-1 of TTS unit 31 (see FIG. 3a). Based on this initial PR of the TO (and possibly on further information on the TO determined by the TTS front-end 31-1, such as stress information, break information, segmentation information and/or context information), an SO with an initial pronunciation is generated in step 303, which step is performed by speech synthesis unit 31-3 of TTS unit 31 (see FIG. 3a).

In step 304, the generated SO is rendered. This may for instance be performed by pronunciation control unit 32 or a further processing stage.

It is then determined in a step 305, if the initial pronunciation of the SO, which initial pronunciation is associated with the initial PR of the TO, is correct.

This step may for instance be actively performed by pronunciation control unit 32 by prompting a user for the decision on the correctness of the initial pronunciation of the SO. Equally well, no active prompting may be performed, and then said pronunciation control unit 32 may for instance passively check if a user takes action to indicate that the initial pronunciation is incorrect. Said action may for instance be hitting a certain function key or speaking a certain word, or similar. In this case, the pronunciation control unit 32 thus generally assumes initial pronunciations of SOs to be correct, and only performs corrections for those single SOs for which a user has indicated that the initial pronunciation is wrong. If it is determined that the initial pronunciation of the SO is correct, the method terminates. Otherwise, according to the present invention, a new PR of the TO is generated in step 306. The sub-steps performed in this step 306 will be discussed with reference to FIG. 3c below. To trigger step 306, pronunciation control unit 32 sends a control signal to the input control unit 30, and input control unit 30 then takes action to have the new PR of the TO determined.

After the determination of the new PR of the TO in step 306, this new PR of the TO is stored in a step 307, and the method terminates. Storage is performed by storage unit 39 (see FIG. 3a).

Returning to step 301, if it is determined that a PR is available for the TO, this stored PR of the TO is retrieved in step 308. This retrieving is triggered by input control unit 30 in interaction with the storage unit 39. Then, in a step 309, an SO is generated from the stored PR of the TO. This is performed by speech synthesis unit 31-3 of TTS unit 31. In a subsequent step 310, the generated SO then is rendered, which may either be performed by pronunciation control unit 32, or by a further processing stage to which the SO may have been output by pronunciation control unit 32 (see FIG. 3a). Thereafter, the method terminates.

FIG. 3c illustrates the sub-steps performed in step 306 of the flowchart of FIG. 3b in order to determine a new PR of the TO according to the first embodiment of a TTS system 3 according to the present invention.

In a first step 320, a spoken representation of the TO is obtained. This is accomplished by recording the voice of a user speaking the TO via speech recorder 33 (see FIG. 3a). This step may further comprise notifying a user that he shall speak the TO, which may for instance be performed by input control unit 30, speech recorder 33 or a further unit. The spoken representation of the TO, i.e. a recorded SO, is then processed by units 34-38 (see FIG. 3a) under control of the selection unit 38. Therein, two different modes of operation may be imagined.

In a first mode, ASR unit 34 generates a set with one or more candidate PRs of the TO at once, based on the recorded SO (and optionally on the TO and/or the initial PR of the TO). This set is then further processed jointly by stages 35-38, wherein in the post processing units 35 and 37, a reduction of the set may be performed by canceling candidate PRs from the set that are not suited to serve as a new PR of the TO. From the remaining candidate PRs, then a user may select the most appropriate one.

In a second mode, ASR unit 34 generates one or more candidate PRs of the TO sequentially, and each of these candidate PRs then is individually processed by stages 35-38. This kind of processing may reduce the overall computational complexity, because, if a user considers already the first candidate PR of the TO to be correct, no processing of further candidate PRs (as in the first mode) is required in units 34-38. In what follows, this second mode of operation is considered.

When generating candidate PRs of the TO, the ASR unit 34 may at least partially use a mapping between TOs and associated PRs of the TOs. Said mapping may for instance initially be a default mapping, which is then enhanced by mappings between TOs and their associated new PRs that have been determined according to the present invention (see step 306 of the flowchart of FIG. 3b) and stored (see step 307 of the flowchart of FIG. 3b) in storage 39 in previous text-to-speech conversions of TOs. Said ASR unit 34 and said TTS unit 31 then may for instance both have access to an instance that stores said mapping of TOs and their associated PRs and that may for instance comprise or implement storage 39. Said mapping may for instance take the shape of a vocabulary that is used by the TTS unit 31 and the ASR unit 34, wherein for each entry (TO) in the vocabulary, a PR exists, and wherein PRs are updated accordingly.

Returning to the flowchart of FIG. 3c, in a step 321, a counter i for the number of candidate PRs of the TO is initialized to zero. It is then checked if a pre-defined maximum number N of PRs of the TO is reached by the counter i. Both steps are performed by selection unit 38 in response to an initial control signal received from input control unit 30. If the maximum number should be reached, the process of determining a new PR of the TO based on the recorded SO is considered to have failed, and a further spoken representation of the TO is recorded in step 320 to serve as a basis for a new attempt to determine the new PR of the TO. The further recorded SO may for instance be more precisely articulated by the user or may contain less noise.

If it is determined in step 322 that the maximum number of PRs of the TO is not reached yet, a candidate PR of the TO is generated based on the recorded SO (and optionally also on the TO itself and/or on the initial PR of the TO), as will be explained in more detail below. This is accomplished by ASR unit 34 (see FIG. 3a) in response to a triggering control signal from selection unit 38.

In a step 324, performed by post processing unit 35, it is checked if said candidate PR of the TO is suited to serve as a new PR of the TO, by applying rules, a language-dependent statistical n-gram technique and/or a pronounceable classifier technique. If said candidate PR of the TO is considered to be not suited (which information is signaled to the selection unit 38 by post processing unit 35), the counter i is increased in step 330, and the method returns to step 322 to avoid further unnecessary processing steps. In step 322, it is then again checked by selection unit 38 if the maximum number N of PRs of the TO is reached, and if this should not be the case, the selection unit 38 triggers the ASR unit 34 to generate a further candidate PR of the TO.

If, in step 324, said candidate PR of the TO is considered to be suited to serve as said new PR of the TO, an SO is generated based on the candidate PR of the TO in step 325. This SO is characterized by a candidate pronunciation that is associated with the candidate PR of the TO. Therein, step 325 is performed by speech synthesis unit 36.

In step 326, it is again checked if said candidate PR of the TO is suited to serve as a new PR of the TO, but this time based on a comparison of the candidate pronunciation of the SO with the pronunciation of the recorded SO. This is performed in post processing unit 37 (see FIG. 3a). If this comparison reveals that the candidate PR of the TO is not suited, this candidate PR of the TO is discarded, the counter i is increased by one in step 330, and the method returns to step 322.

If the candidate PR of the TO is still considered to be suited to serve as a new PR of the TO, the SO with the corresponding candidate pronunciation is rendered in step 327, which step is performed by selection unit 38 or a further unit. If is then checked if the candidate pronunciation of the SO is correct, by communicating with the user. These steps are performed or triggered by selection unit 38. If the candidate pronunciation turns out to be incorrect, the counter i is increased in step 330, and the method returns to step 322. Otherwise, the candidate PR of the TO associated with the correct candidate pronunciation is determined to be the new PR of the TO in step 329, and the method terminates. Step 329 is also performed by selection unit 38 (see FIG. 3a).

According to this first embodiment of the TTS system 3 (see FIG. 3a) according to the present invention, when the user hears an incorrect pronunciation of an SO initially generated by the TTS system 3, she/he can train the TTS system 3 the correct (new) pronunciation by simply saying the difficult text object in the proper way. The TTS system 3 then learns the correct pronunciation using a phoneme-loop ASR system. The number of possible pronunciations is reduced by pruning out some invalid pronunciations using some applicable post-processing techniques (rules, language-dependent statistical n-gram, pronounceable classifier). Usually, the recognition still may not be performed 100% reliably, and thus the user may be offered the opportunity to select the correct pronunciation from the list of most probable pronunciation candidates. After the teaching process has been successfully finished, the TTS system permanently learns the difficult text object by storing the correct (new) pronunciation into its internal pronunciation module.

Although even the state-of-the-art phoneme-loop ASR systems may not reach very high recognition accuracy, this does not hinder the practicability or usefulness of the present invention. The constrained recognition task (the determination of one or more candidate PRs of the TO) needed in the embodiments of the present invention comprises several features that facilitate the recognition process:
It is possible to get a good estimate about the range of the number of phonemes in the PR of the TO since the typical target may be to recognize only one or two isolated words (text objects), for which the written form is already known. In addition to the recorded SO, thus also the TO can be fed into the ASR unit 34 of the TTS system 3 in FIG. 3a.
In ASR, there is no need to go beyond the phoneme level and, consequently, there is no need to solve the disambiguation problem when there are two or more words or phrases that have a very similar or even identical pronunciation despite of different written forms (e.g. “gray day” and “grade A” have a similar pronunciation, but different spellings).
The number of possible alternatives for the PR of the TO is limited since the written form of the TO is already known. Therefore, in addition to the recorded SO, also the TO itself can be fed into the ASR unit 34 of the TTS system 3 in FIG. 3a.
It is usually possible to limit the problem to a sub-part of each possible PR (e.g. to only some phonemes of a PR of a TO) by analyzing the differences initial pronunciation of the SO and the pronunciation given by the user, represented by the recorded SO. To this end, in addition to the recorded SO, also the initial PR of the TO can be fed into the ASR unit 34 of the TTS system 3 in FIG. 3a.
In the TTS system 3 in FIG. 3a, it is possible to synthesize the TO using alternative recognition results (the one or more candidate PRs of the TO generated by the ASR unit 34) and to compare these recognition results to the recorded SO. A quick analysis of differences can rule out some of the alternatives or, in the best case, find the correct pronunciation. To this end, the recorded SO is fed into post processing instance 37 of the TTS system 3 in FIG. 3a.
Some of the candidate pronunciations might be impossible to pronounce in practice or against linguistic rules. Thus, it is possible to prune out some alternatives by exploiting this fact using post processing techniques such as rules, language-dependent statistical n-gram techniques and/or pronounceable classifier techniques. These techniques are applied in post processing unit 35 of TTS system 3 (see FIG. 3a).
The user can assist the process in cases in which there are several potential candidate pronunciations. This functionality is implemented in selection unit 38 of TTS system 3 (see FIG. 3a).

Consequently, according to the first embodiment of the present invention, even a phoneme-loop ASR unit with moderate performance can be used, which contributes to reducing the complexity of the TTS system according to the present invention.

### Second Embodiment of the Invention

The second embodiment of the present invention uses a TTS unit instead of an ASR unit to generate one or more candidate PRs of a TO. Nevertheless, a spoken representation of the TO is considered in the process of selecting the new PR of the TO from the candidate PRs of the TO.

FIG. 4a presents a schematic block diagram of this second embodiment of a TTS system 4 according to the present invention. The second embodiment of the TTS system 4 differs from the first embodiment of the TTS system 3 (see FIG. 3a) only by the fact that the ASR unit 34 of TTS system 3 has been replaced by a TTS front-end 44, and that a post processing unit corresponding to post processing unit 35 of TTS system 3 is no longer present in TTS system 4. Consequently. the functionality of units 40-43, and 46-49 of the TTS system 4 of FIG. 4a corresponds to the functionality of the units 30-33 and 36-39 of the TTS system 3 of FIG. 3a and thus needs no further explanation at this stage.

TTS front-end 44 of TTS system 4 (see FIG. 4a) basically has the same functionality as the TTS front-end 41-1 of the TTS unit 41, i.e. is capable of using its automatic phonetization unit 44 to segment a TO received from input control unit 40 into a PR of the received TO (and possibly to generate further information such as stress information, break information, segmentation information and/or context information). However, TTS front-end 44 is capable of generating not only one (usually the most probable) PR of the TO (possibly with further associated information such as stress information, break information, segmentation information and/or context information), but several candidate PRs of the TO. These candidate PRs of the TO may for instance comprise the most probable PR of the TO and also less probable PRs of the TO, for instance sorted according to their estimated probability. The initial PR of the TO, received from the input control unit 40, may also be considered in the process of generating the one or more candidate PRs of the TO, for instance by discarding candidate PRs of the TO that resemble the initial PR of the TO. TTS front-end 44 is further capable of forwarding these one or more candidate PRs of the TO (possibly with associated information such as stress information, break information, segmentation information and/or context information) to speech synthesis instance 46.

It should be noted that, as in the first embodiment of the TTS system 3, it is also possible in the second embodiment of the TTS system 4 to perform the determination of the new PR of the TO in stages 44 and 46-48 according to two modes. In the first mode, a set of candidate PRs of the TO is generated by TTS front-end 44 at once, and this set of candidate PRs of the TO is jointly processed in each of the stages 46-48. Alternatively, candidate PRs of the TO are sequentially generated by TTS front-end 44 and individually processed by stages 46-48. In the sequel, the latter case will be exemplarily considered.

As already mentioned above, the general method steps performed by all three embodiments of TTS systems according to the present invention are reflected by the flowchart in FIG. 3b. Only the step 306 of determining a new PR of the TO differs among the embodiments. For the second embodiment, the sub-steps 400-408 of this step 306 are detailed in FIG. 4b.

Therein, the method steps 420-430 of the flowchart of FIG. 4b (second embodiment) correspond to the method steps 320-330 of the flowchart of FIG. 3b (first embodiment) with only two decisive differences.

First, with respect to step 423, it is noted that the candidate PR of the TO is not generated based on at least the spoken representation of the TO, as it is the case in step 323 of FIG. 3b (first embodiment of a TTS system 3), but based on the TO itself. This is due to the fact that the second embodiment of a TTS system 4 does not comprise an ASR unit, and uses the TTS front-end 44 to generate the one or more candidate PRs of the TO instead.

Second, after the generation of the candidate PR of the TO in step 423, an SO is directly generated from the PR of the TO in step 425 (and possibly further associated information such as stress information, break information, segmentation information and/or context information) without a further suitability check on the candidate PR of the TO (cf. step 424 of the flowchart of FIG. 3c). Nevertheless, such a check may also be adopted in the flowchart of FIG. 4b.

According to this second embodiment of the TTS system 4 (see FIG. 4a) according to the present invention, the user articulates the correct pronunciation using her/his voice. This utterance spoken by the user is not used as a basis for the generation of the candidate PRs of the TO, but compared against the SOs generated from the most probable candidate PRs of the TO that could represent the TO and that are generated by an automatic phonetization unit based on the TO itself. If the comparison shows that there are two or more good candidate PRs of the TO, the user is offered the chance to select the user-preferred pronunciation from the list of alternatives (which selection can be performed for all PRs of the TO at once, or sequentially). With this approach, the present invention can be used even in cases in which there is no ASR unit available. However, the expected performance may be somewhat lower than with the ASR-based first embodiment, and for full performance of the TTS system, the TTS front-end 44 should advantageously be able to come up with several candidate PRs of the TO instead of just one to increase diversity.

### Third Embodiment of the Invention

Similar to the second embodiment of the present invention, also the third embodiment of the present invention uses a TTS unit to generate one or more candidate PRs of a TO. However, in contrast to the second embodiment (see FIG. 4a), no speech input from a user is required.

FIG. 5a presents a schematic block diagram of this third embodiment of a TTS system 5 according to the present invention. The fact that no speech input of the user is processed is reflected by the fact that no speech recorder for recording an SO and no post processing unit exploiting such a recorded SO is used. The functionality of the units 50-52, 54, 56 and 58-59 of the TTS system 5 corresponds to the functionality of the units 40-42, 44, 46 and 48-49 of the TTS system 4 (see FIG. 4a) and thus does not require further explanation.

As in the first and second embodiments of TTS systems according to the present invention, it is also possible in the third embodiment of a TTS system 5 to perform the determination of the new PR of the TO in stages 54, 56 and 58 according to two modes. In the first mode, a set of candidate PRs of the TO is generated by TTS front-end 54 at once, and this set of candidate PRs of the TO is jointly processed in each of the stages 56 and 58. Alternatively, candidate PRs of the TO are sequentially generated by TTS front-end 54 and individually processed by stages 56 and 58. In the sequel, the latter case will be exemplarily considered.

As already mentioned above, the general method steps performed by all three embodiments of TTS systems according to the present invention are reflected by the flowchart in FIG. 3b. Only the step 306 of determining a new PR of the TO differs among the embodiments. For the third embodiment, the sub-steps 500-507 of this step 306 are detailed in FIG. 5b.

In a first step 500, the counter i for the PR of the TO is initialized to zero. It is then checked if a maximum number N of PRs of the TO already has been reached in a step 501. Both steps are performed by selection unit 58 (see FIG. 5a). In step 502, then a candidate PR of the TO is generated based on the TO (possibly with further associated information such as stress information, break information, segmentation information and/or context information). This is performed by the TTS front-end 54. From the generated candidate PR of the TO (and possibly the further associated information), then an SO is generated in step 503 by speech synthesis unit 56. This SO is then rendered in a step 504, either by the selection unit 58 or a further unit. It is then determined in a step 505 if the candidate pronunciation of the generated SO is correct, which is also performed by selection unit 58. If this is the case, the candidate PR of the TO is determined to be the new PR of the TO in step 506. Otherwise, the counter i is increased by one, and the method jumps back to step 501. All of these steps are performed by selection unit 58.

If it is determined in step 501 that the maximum number N of PRs of the TO has been reached, obviously none of the N PRs of the TO presented to the user so far have been considered to be correct. As the probability that further candidate PRs of the TO generated by the TTS front-end 54 (see FIG. 5a) are correct may generally decrease with increasing numbers of candidate PRs, it is thus advisable to output a message to inform the user that no further candidate PRs of the TO will be generated, and that the method will start again from the beginning (then of course producing the same candidate PRs of the TO as in the previous loops). This is performed in steps 508, which then jumps back to step 500. The rationale behind this approach is to give the user a chance to reconsider previously refused pronunciations.

According to this third embodiment of the TTS system 5 (see FIG. 5a) according to the present invention, the user does not verbally express the correct pronunciation, but just selects the correct pronunciation from the list of most probable candidate PRs of the TO. Compared to the second embodiment of the present invention, this saves a speech recorder and a post processing unit. As in the second embodiment of the TTS system, it is advantageous that the TTS front-end 54 is capable of generating more than one candidate PRs of the TO.

The present invention has been described above by means of exemplary embodiments. It should be noted that there are alternative ways and variations which will be evident to anyone of skill in the art and can be implemented without deviating from the scope and spirit of the appended claims. In particular, the invention can be used with all kinds of TTS systems and in all kinds of applications. It may be particularly suited for applications in which the TTS system is used for synthesizing isolated text objects (e.g. words), and in which the vocabulary of the text objects is extensible but still limited. Nevertheless, the invention may also bring great advantages when used in connection with a TTS system that synthesizes arbitrary full sentences of continuous speech.

The present invention provides at least the following advantages:
The present invention allows the user to train the TTS system how to pronounce difficult text objects (e.g. words).
The present invention is not platform-specific or application-specific and thus can be used in many kinds of products.
The present invention can be used with all kinds of TTS systems from low-footprint formant-based synthesizers to high-footprint concatenation-based systems.
Although a phoneme-loop ASR system is needed for the first embodiment of the present invention, the present invention can be expected to work well using an ASR system with only a moderate performance. Moreover, if necessary, it is also possible to implement the invention without using ASR techniques, as it is the case with the second and third embodiments of the present invention.
The corrected voice prompt (i.e. the speech object with the new pronunciation) is given in the same voice as all the other voice prompts (i.e. speech objects with initial or new pronunciations).
The present invention provides a very useful addition to any TTS framework.
The additional implementation complexity caused by the present invention is moderate because the TTS and ASR functionality is already a standard feature in many portable devices, such as for instance mobile phones. Additional tasks to be implemented comprise building up an interaction algorithm between the TTS and ASR components and introducing some modifications to the standard TTS and ASR components.
Finally, the improved pronunciation module may enhance the ASR performance. This may be particularly the case if the ASR system, when performing speech recognition, uses a mapping between text objects and their associated PRs that is updated by mappings between TOs and their associated new PRs as determined by the present invention (for instance in the steps of the flowchart of FIG. 3c).

1. A method for correcting a pronunciation of a speech object, wherein said speech object is synthetically generated from a text object in dependence on a segmented representation of said text object, said method comprising:
determining if an initial pronunciation of said speech object, which initial pronunciation is associated with an initial segmented representation of said text object, is incorrect; and
determining, in case it is determined that said initial pronunciation of said speech object is incorrect, a new segmented representation of said text object, which new segmented representation of said text object is associated with a new pronunciation of said speech object.

2. The method according to claim 1, further comprising:
storing said new segmented representation of said text object to serve as a basis for a synthetic generation of said speech object with said new pronunciation.

3. The method according to claim 1, wherein said determining of said new segmented representation of said text object comprises:
generating one or more candidate segmented representations of said text object, wherein each of said one or more candidate segmented representations of said text object is associated with a respective candidate pronunciation of said speech object, and
selecting said new segmented representation of said text object from said one or more candidate segmented representations of said text object.

4. The method according to claim 3, wherein said selecting comprises:
prompting a user to select said new segmented representation of said text object from said one or more candidate segmented representations of said text object.

5. The method according to claim 3, wherein said generating of said one or more candidate segmented representations of said text object comprises:
obtaining a representation of said text object spoken by a user; and
converting said spoken representation of said text object into said one or more candidate segmented representations of said text object.

6. The method according to claim 5, wherein said converting is performed by an automatic speech recognition algorithm.

7. The method according to claim 5, wherein a written form of said text object is considered in said converting of said spoken representation of said text object.

8. The method according to claim 5, wherein a difference between said initial pronunciation of said speech signal and a pronunciation of said spoken representation of said text object is considered in said converting of said spoken representation of said text object.

9. The method according to claim 5, wherein said selecting comprises:
automatically assessing a suitability of at least one of said one or more candidate segmented representations of said text object to serve as said new segmented representation of said text object; and
discarding said at least one candidate segmented representation of said text object, if it is assessed to be not suitable to serve as said new segmented representation of said text object.

10. The method according to claim 9, wherein said assessing is based on at least one of rules, a language-dependent statistical n-gram technique and a pronounceable classifier technique.

11. The method according to claim 9, wherein said assessing is based on comparing a pronunciation of said spoken representation of said text object with the candidate pronunciation associated with said at least one candidate segmented representation of said text object.

12. The method according to claim 3, wherein said generating of said one or more candidate segmented representations of said text object comprises:
converting said text object into said one or more candidate segmented representations of said text object.

13. The method according to claim 12, wherein said converting is performed by an automatic segmentation algorithm.

14. The method according to claim 12, wherein said selecting comprises:
obtaining a representation of said text object spoken by a user;
automatically assessing a suitability of at least one of said one or more candidate segmented representations of said text object to serve as said new segmented representation of said text object, wherein said assessing is based on comparing a pronunciation of said spoken representation of said text object with the candidate pronunciation associated with said at least one candidate segmented representation of said text object; and
discarding said at least one candidate segmented representation of said text object, if it is assessed to be not suitable to serve as said new segmented representation of said text object.

15. A device for correcting a pronunciation of a speech object, wherein said speech object is synthetically generated from a text object in dependence on a segmented representation of said text object, said device comprising:
means arranged for determining if an initial pronunciation of said speech object, which initial pronunciation is associated with an initial segmented representation of said text object, is incorrect; and
means arranged for determining, in dependence on said determination if said initial pronunciation of said speech object is incorrect, a new segmented representation of said text object, which new segmented representation of said text object is associated with a new pronunciation of said speech object.

16. The device according to claim 15, further comprising:
means arranged for storing said new segmented representation of said text object, which serves as a basis for a synthetic generation of said speech object with said new pronunciation.

17. The device according to claim 15, wherein said means arranged for determining said new segmented representation of said text object comprises:
means arranged for generating one or more candidate segmented representations of said text object, wherein each of said one or more candidate segmented representations of said text object is associated with a respective candidate pronunciation of said speech object and
means arranged for selecting said new segmented representation of said text object from said one or more candidate segmented representations of said text object.

18. The device according to claim 17, wherein said means arranged for selecting said new segmented representation of said text object from said one or more candidate segmented representations of said text object comprises:
means arranged for prompting a user to select said new segmented representation of said text object from said one or more candidate segmented representations of said text object.

19. The device according to claim 17, wherein said means arranged for generating said one or more candidate segmented representations of said text object comprises:
means arranged for obtaining a representation of said text object spoken by a user; and
means arranged for converting said spoken representation of said text object into said one or more candidate segmented representations of said text object.

20. The device according to claim 19, wherein said means arranged for selecting said new segmented representation of said text object from said one or more candidate segmented representations of said text object comprises:
means arranged for automatically assessing a suitability of at least one of said one or more candidate segmented representations of said text object to serve as said new segmented representation of said text object; and
means arranged for discarding said at least one candidate segmented representation of said text object, in case it is assessed to be not suitable to serve as said new segmented representation of said text object.

21. The device according to claim 17, wherein said means arranged for generating said one or more candidate segmented representations of said text object comprises:
means arranged for converting said text object into said one or more candidate segmented representations of said text object.

22. The device according to claim 21, wherein said means arranged for selecting said new segmented representation of said text object from said one or more candidate segmented representations of said text object comprises:
means arranged for obtaining a representation of said text object spoken by a user;
means arranged for automatically assessing a suitability of at least one of said one or more candidate segmented representations of said text object to serve as said new segmented representation of said text object, wherein said assessing is based on comparing a pronunciation of said spoken representation of said text object with the candidate pronunciation associated with said at least one candidate segmented representation of said text object; and
means arranged for discarding said at least one candidate segmented representation of said text object in case it is assessed to be not suitable to serve as said new segmented representation of said text object.

23. The device according to claim 15, wherein said device is a portable telecommunications device or a part thereof.

24. A software application product for correcting a pronunciation of a speech object, wherein said speech object is synthetically generated from a text object in dependence on a segmented representation of said text object, said software application product being embodied within a computer readable medium and being configured to perform the steps of:
determining if an initial pronunciation of said speech object, which initial pronunciation is associated with an initial segmented representation of said text object, is incorrect; and
determining, in case it is determined that said initial pronunciation of said speech object is incorrect, a new segmented representation of said text object, which new segmented representation of said text object is associated with a new pronunciation of said speech object.
